(19) United States
(12) Patent Application Publication
(10) Pub. No.: US 2018/0104971 A1
(43) Pub. Date: Apr. 19, 2018

(54) PRINTING APPARATUS AND CONTROL METHOD THEREFOR, AND STORAGE MEDIUM

(71) Applicant: CANON KABUSHIKI KAISHA, Tokyo (JP)

(72) Inventor: Naoto Takahashi, Saitama-shi (JP)

(21) Appl. No.: 15/722,954

(22) Filed: Oct. 2, 2017

(30) Foreign Application Priority Data
Oct. 13, 2016 (JP) 2016-202037

(51) Int. Cl. B41J 29/38; H02J 50/10

(52) U.S. Cl. CPC B41J 29/38; H02J 50/10

(57) ABSTRACT

A printing apparatus includes a carriage including an ink head that ejects ink onto a printing medium and a power reception unit that wirelessly receives power, a power transmission unit that wirelessly transmits the power to the power reception unit, and a control unit that controls the amount of power transmitted from the power transmission unit to the power reception unit based on an operational state of the printing apparatus.

### BACKGROUND

### Field

The present disclosure relates to a printing apparatus and a control method therefor, and a storage medium. The disclosure particularly relates to a printing apparatus that wirelessly transmits and receives power.

### Description of the Related Art

In general, a printer such as an inkjet printer, has the following configuration. An ink head configured to eject ink and a driving circuit configured to drive the ink head are mounted to a carriage, and the carriage can be moved with respect to a casing of the printer. A small-sized printer can also be provided with an ink tank in some cases.

To supply power used for an operation of a head unit or the like mounted to the carriage, the above-described printer generally has a configuration in which a power supply provided outside the carriage of the printer and the carriage are connected with each other via a physical wiring. Specifically, the configuration is realized by using a flexible flat cable (FFC) as a wiring for supplying power to the carriage.

The ink head of the carriage performs a printing operation by ejecting ink during a reciprocating operation at the time of printing on a printing medium such as paper. The FFC accumulates metal fatigue from the mechanical reciprocating operations of the carriage based on the repeated printing operations and is cut when the FFC passes a certain lifespan. In view of the above-described situation, a technology for unwiring the FFC, i.e., wireless power transmission, has been proposed.

Japanese Patent Laid-Open No. 2015-223804 describes that power transmission to the carriage in the printing apparatus is unwired. According to this configuration, wireless power transmission is performed from the printer to the carriage by a field coupling method.

However, according to Japanese Patent Laid-Open No. 2015-223804, power transmission control in accordance with a state of the printing apparatus is not taken into account. For example, while a user is replacing an ink tank, if power transmission for warming up a heater of the ink head continues, there is a possibility that a defect or wasteful power consumption can occur.

### SUMMARY

In view of the above-described circumstances, according to an aspect of the present disclosure, there is provided a printing apparatus including an ejection unit configured to eject ink supplied from a detachable ink tank, a power transmission unit configured to wirelessly supply power for the ejection unit to eject the ink, a member including a first state in which detaching or mounting the ink tank is enabled and a second state in which detaching or mounting the ink tank is restricted, and a control unit configured to set, when the member is in the first state, an amount of the wirelessly supplied power lower than an amount of the wirelessly supplied power when the member is in the second state.

Further features will become apparent from the following description of exemplary embodiments with reference to the attached drawings.

### BRIEF DESCRIPTION OF THE DRAWINGS

FIG. 1 is a schematic diagram for describing a printing operation in a printer.

FIG. 2 is a top view illustrating configurations of power transmission and reception antennas and a carriage.

FIG. 3 is a front view illustrating the configurations of the power transmission and reception antennas and the carriage.

FIG. 4 is a block diagram illustrating a hardware configuration of the printer.

FIG. 5 is a flow chart illustrating an operation procedure of the printer.

FIG. 6 is a flow chart illustrating the operation procedure of the printer.

### DESCRIPTION OF THE EMBODIMENTS

Hereinafter, exemplary embodiments will be described in detail with reference to the accompanying drawings. According to the exemplary embodiments, a technology is provided with which power transmission control based on a state of a printing apparatus that performs wireless power transmission can be performed in the printing apparatus.

### First Exemplary Embodiment

According to a first exemplary embodiment, descriptions will be given of a configuration in which a printer (printing apparatus) that transmits power to a carriage 101 using wireless power transmission changes the amount of transmitted power based on a state of the printer, e.g., at the start of printing, during printing, at the end of printing, or the like.

### Printer

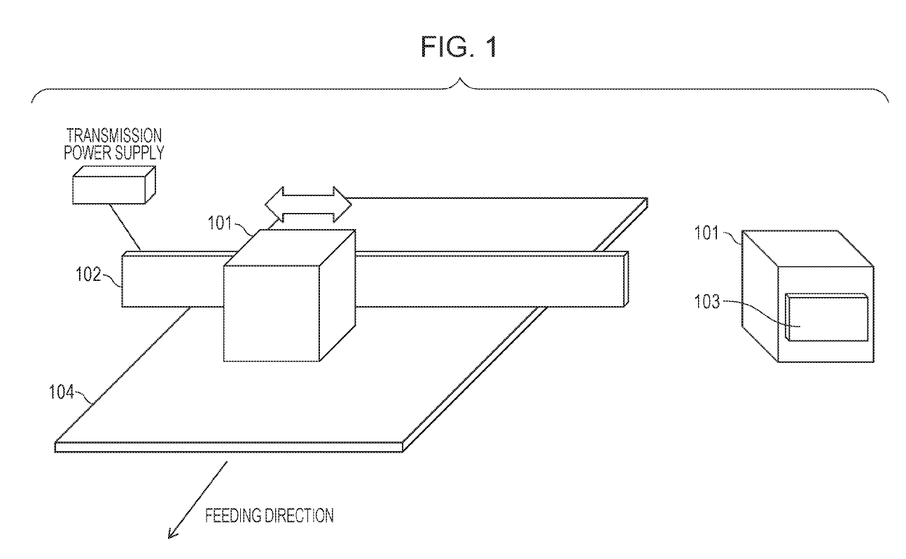

FIG. 1 is a schematic diagram illustrating a printing operation for forming an image by ejecting ink onto a printing medium in a printer. In FIG. 1, an ink head is mounted to a carriage 101. The ink head of the carriage 101 performs printing by ejecting the ink onto a printing medium 104 such as paper (printing sheet). A power transmission antenna 102 wirelessly transmits power to the carriage 101. A power reception antenna 103 is included in the carriage 101. The power reception antenna 103 wirelessly receives the power transmitted from the power transmission antenna 102 and supplies the power into the carriage 101. The printing medium 104 receives the ink ejected from the ink head included in the carriage 101 while moving in the feeding direction as illustrated in FIG. 1 (feeding direction) to form an image on the printing medium 104.

FIG. 1 illustrates an example in which the power transmission antenna 102 is arranged perpendicular to the printing medium 104, and the power reception antenna 103 is arranged in the rear of the carriage 101 with respect to a travelling direction (feeding direction) of the printing medium 104, but the arrangement location is not limited to this. For example, in another configuration the power transmission antenna 102 is arranged in parallel with the printing medium 104, and the wireless power transmission to the power reception antenna 103 is performed from the top of the carriage 101. Wireless power transmission can also be performed while the power transmission antenna 102 is arranged at a bottom of the carriage 101, i.e., on a bottom side of the printing medium 104.

The power transmission antenna 102 illustrated in FIG. 1 can also be arranged on a front side with respect to the printing medium 104, that is, the feeding direction as viewed from the carriage 101. A plane on which the power transmission antenna 102 is formed does not necessarily need to be in parallel with a plane on which the power reception antenna 103 is formed, and these antennas can also be arranged at an angle, e.g., 45° to each other. In this manner, since the arrangement of the power transmission antenna 102 and the power reception antenna 103 is arbitrary, the power transmission and reception antennas can be arranged at positions where the wireless power transmission is not affected based on a structure of the printer, where an arrangement of a metal member in the printer can affect the wireless power transmission, or the like.

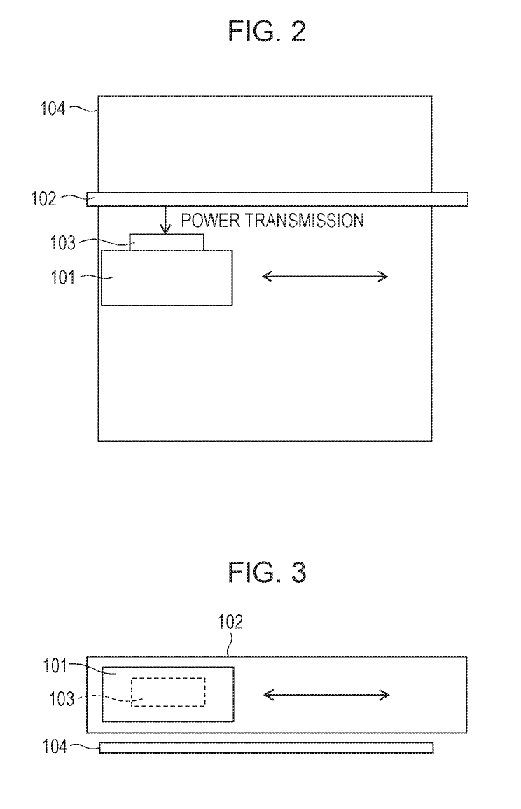

FIG. 2 is a top view of an operation performed by the carriage 101, the printing medium 104, the power transmission antenna 102, and the power reception antenna 103. FIG. 3 is a front view of the operation performed by the carriage 101, the printing medium 104, the power transmission antenna 102, and the power reception antenna 103. The power transmission antenna 102 wirelessly performs power transmission to the power reception antenna 103 included in the carriage 101 and supplies die power into die carriage 101. The carriage 101 ejects the ink onto the printing medium 104 and performs the printing in accordance with the power supply.

As indicated by a left right arrow in FIG. 2 and FIG. 3, the carriage 101 ejects the ink onto the printing medium 104 while repeatedly moving in left and right directions along the power transmission antenna 102 on the paper plane of FIG. 2 and FIG. 3. When the scanning is performed over the entirety of the printing medium 104 as described above, the image is formed on the printing medium 104. The carriage 101 uses the supplied power for the operation of ejecting the ink.

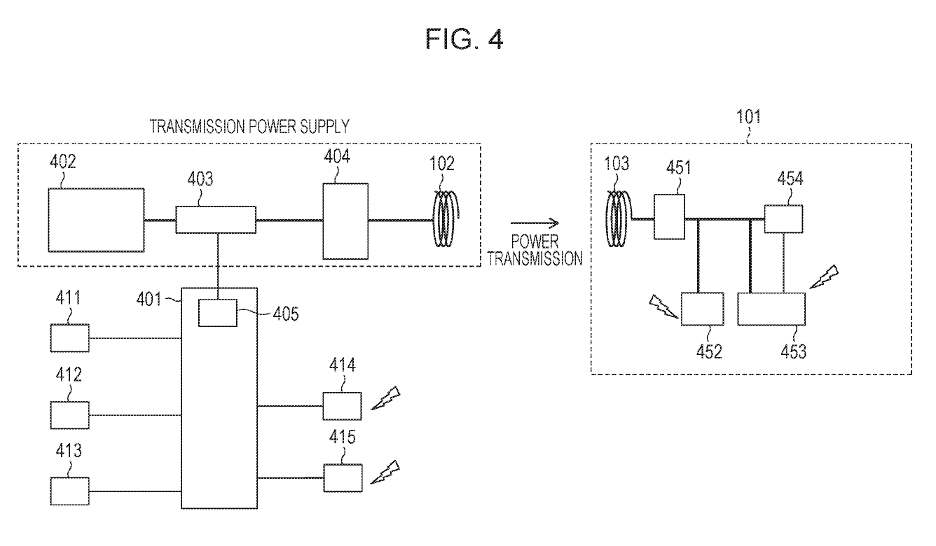

FIG. 4 is a block diagram illustrating a hardware configuration of the printer. A central processing unit (CPU) 401 is configured to control the overall operation of the printer. A power supply unit 402 supplies power to the carriage 101 for the power transmission via wireless power transmission. A chopper circuit 403 sets an appropriate voltage value when the wireless power transmission to the carriage 101 is performed via the power transmission antenna 102. A power supply unit 404 includes a DC-AC inverter function that converts direct current (DC) power to alternating current (AC) power.

A power supply control unit 405 is arranged in the central processing unit 401. The power supply control unit 405 controls the chopper circuit 403 to determine the electric power amount of the wireless power transmission transmitted from the power supply unit 404 and the power transmission antenna 102. According to the present exemplary embodiment, the example is described in which the power supply control unit 405 is arranged in the central processing unit 401, but the arrangement position of the power supply control unit 405 can also be external to the central processing unit 401. The central processing unit 401 and the power supply control unit 405 are provided as dedicated-use logic circuits, but can also be realized by loading computer programs into programmable logic circuits.

The power supply control unit 405 controls the electric power value of the wireless power transmission by changing the voltage value applied to the chopper circuit 403. For example, when the voltage value input to the chopper circuit 403 (control voltage value) is high based on a configuration of the chopper circuit 403, the electric power value input to the power supply unit 404 is increased. As a result, the transmission power for the wireless power transmission output from the power transmission antenna 102 is increased. When the control voltage value is low, the electric power value input to the power supply unit 404 is decreased. As a result, the transmission power output from the power transmission antenna 102 is decreased.

The above-described control is an example. The electric power value of the transmission power can also be decreased based on the increase in the control voltage value according to the configuration of the chopper circuit 403. A range of a voltage that can be input is previously set for the control voltage value of the chopper circuit 403 in many cases.

The power supply control unit 405 of the printer according to the present exemplary embodiment switches the transmission power based on its operation state. According to the present exemplary embodiment, the states of the printer are classified into four states, and the transmission power amount of the wireless power transmission in each state is determined as follows:

Transmission power A (control voltage V1) corresponds to the electric power amount in a case where the wireless power transmission is performed for warming up an ink head 454. Transmission power B (control voltage V2) corresponds to the electric power amount in a case where the wireless power transmission is performed during the ejection of the ink from the ink head 454 of the carriage 101.

Transmission power C (control voltage V3) corresponds to the electric power amount in a case where the wireless power transmission is performed during a replacement of an ink tank.

Transmission power D (control voltage V4) corresponds to the electric power amount transmitted by the printer via the wireless power transmission while the printer is in a standby state.

According to the present exemplary embodiment, since the power transmission to the carriage 101 is not performed when the printer is in a standby state, the transmission power D=0 is set. In addition, the transmission power A>the transmission power B>the transmission power C the transmission power D=0 is satisfied.

In this manner, according to the present exemplary embodiment, the control voltage value is changed based on a state in the printer. In a case where the ink head 454 is warmed up when the printer starts the printing according to the present exemplary embodiment, the control voltage is changed based on the state of the printer, such as, for example, a case where an opening and closing part for the ink replacement is opened when the ink has been consumed. Since the power transmission is performed at the appropriate electric power based on the state of the printer, it is possible to reduce unnecessary power transmission.

In addition, the electric power amount of the wireless transmission is decreased in a state in which the user is likely to touch the printer by hand or the like, and the electric power amount is increased in a state in which the user is unlikely to touch the printer, so that it is possible to avoid a risk of an electric shock to the user. The method for classifying the state of the printer, the number of transmission power levels, and the like are not limited to the above-described examples, and can be designed based on the configuration or the use of the printer.

In FIG. 4, a sensor 411 detects whether the opening and closing part for the ink replacement is open at the time of the replacement of the ink tank mounted to the carriage 101 or the like. The opening and closing part is a casing of the printer that covers the carriage 101. A detection result by the sensor 411 with regard to the opening and closing part for the ink replacement is input to an input port of the central processing unit 401. For this reason, the central processing unit 401 can determine the state in which the opening and closing part for the ink replacement is open or closed in real time. Detachment or mounting of the ink tank can be performed in a case where the opening and closing part is open, and detachment or mounting of the ink tank are restricted in a case where the opening and closing part is close.

A detection unit 412 detects a signal for starting printing on the printing medium 104 by the carriage 101. Since the detection result by the detection unit 412 is input to the input port of the central processing unit 401, the central processing unit 401 can determine whether the printing is started in real time.

A detection unit 413 detects whether the printing medium 104 is inverted at the time of duplex printing. A detection result by the detection unit 413 is input to the input port of the central processing unit 401. For this reason, the central processing unit 401 can determine whether the printing medium is inverted in real time.

An ink remaining amount detection unit 414 (hereinafter referred to as “ink detection unit”) receives a result by an ink remaining amount detection sensor 452 (hereinafter referred to as “ink sensor”) included in the carriage 101. The ink sensor 452 and the ink detection unit 414 both include a wireless communication device, and the detection result of the ink remaining amount of the ink tank is transmitted from the ink sensor 452 to the ink detection unit 414 via wireless communication. The wireless communication can be performed by a method such as, for example, a wireless LAN or Bluetooth®.

A print data transmission unit 415 (hereinafter referred to as “data transmission unit”) is configured to transmit print data to be printed on the printing medium 104 to a printing data reception unit 453, which will be described below. The data transmission unit 415 includes a wireless communication device similar to the ink detection unit 414. The print data received from an information processing apparatus, such as a personal computer (not illustrated) is transmitted to the central processing unit 401 and transferred to the carriage 101 to be printed using the ink head 454. The print data is transmitted to the printing data reception unit 453 (hereinafter referred to as “data reception unit”) included in the carriage 101 using the wireless communication device of the data transmission unit 415 and printed on the printing medium 104 from the ink head 454.

A rectification unit 451 included in the carriage 101 receives power from the power transmission antenna 102 via wireless power transmission and converts the power received in the power reception antenna 103 into DC power. This DC power is supplied to the entirety of the carriage 101 and consumed for performing the printing operation such as, for example, the ink ejection.

The component used for the printing is not limited to this and various modes are conceivable. The configuration and the operation illustrated in the present exemplary embodiment are examples. For example, a memory or a storage that stores a computer program, data, or the like that is read and executed by the central processing unit 401 can be provided, and the central processing unit 401 can control the operation of the printer based on this computer program or data.

### Transmission Power Control

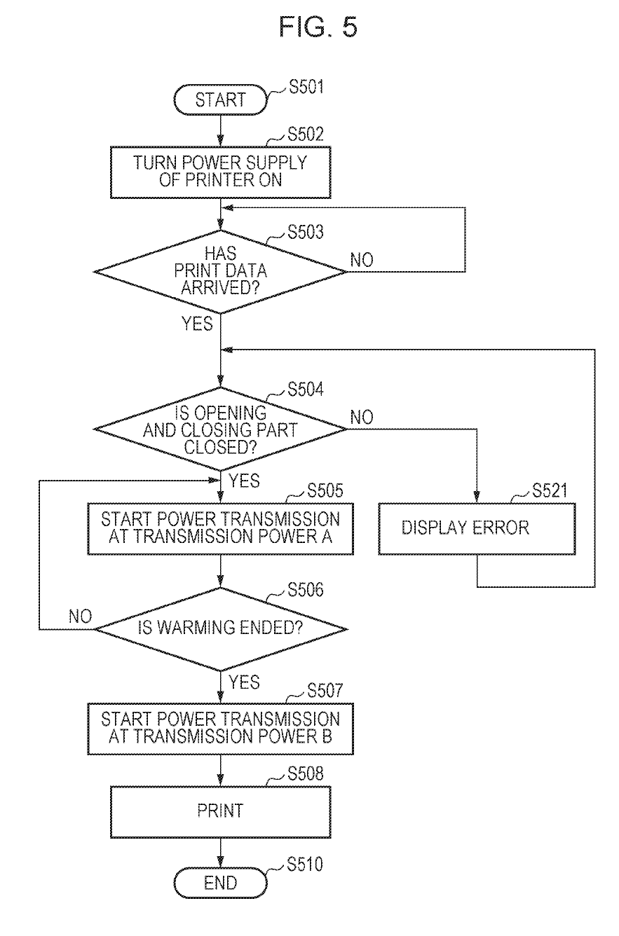

With reference to FIG. 5, descriptions will be provided of control on the transmission power in the wireless power transmission at the time of the operation for warming up the ink head 454 and ejecting the ink onto the printing medium 104 to perform the printing in the printer that wirelessly performs the power transmission to the carriage 101. FIG. 5 a flow chart illustrating an operation procedure of the printer according to the present exemplary embodiment. Respective steps in FIG. 5 are executed while the central processing unit 401 controls the respective components of the printer.

The process starts in S501, and the power supply of the printer is turned on (S502). The printer enters a standby state in which the print data can be received from an information processing apparatus, such as a personal computer, a smart phone, or a tablet terminal (S503). This state is maintained in a case where the print data has not arrived (S503: NO). Since this state corresponds to the standby state of the printer, the wireless power transmission to the carriage 101 is not performed. That is, the control voltage from the power supply control unit 405 in the central processing unit 401 to the chopper circuit 403 is set as V4, and the transmission power is set as D (=0), so that the wireless power transmission to the carriage 101 is not performed.

In a case where the print data is input to the printer (S503: YES), the state of the opening and closing part where the ink replacement of the printer is performed is determined by the central processing unit 401 using the sensor 411 (S504). When the opening and closing part is in the open state (S504: NO), an error is displayed on a display unit (not illustrated) or the like of the printer (S521) to urge the user to close the opening and closing part, and the detection is performed again using the sensor 411 (S504). In a case where it is detected that the opening and closing part is closed (S504: YES), the process proceeds to S505.

In S505, the power supply control unit 405 of the central processing unit 401 inputs the control voltage V1 to the chopper circuit 403. As a result, the power supply unit 404 wirelessly transmits the transmission power A corresponding to the control voltage V1 from the power transmission antenna 102 towards the power reception antenna 103 of the carriage 101. The carriage 101 converts the received power into DC power in the rectification unit 451 that is to he supplied to a heater unit (not illustrated) that warms up the ink head 454. As a result, a heater is warmed up. The power transmission at the transmission power A is continued until warming of the heater ends (S506: NO). With this operation, appropriate power to warm up the carriage's 101 heater is wirelessly transmitted without excess or deficiency.

In a case where warming of the heater ends (S506: YES), the process shifts to a printing operation for ejecting the ink onto the printing medium 104 (S507). The power consumption of the carriage 101 used for the printing operation is the transmission power B. In view of the above, the power supply control unit 405 inputs the control voltage V2 to the chopper circuit 403, and the transmission power B is output from the power supply unit 404 to the chopper circuit 403, so that the wireless power transmission from the power transmission antenna 102 to the power reception antenna 103 is performed (S507).

The carriage 101 performs the printing operation by ejecting the ink from the ink head 454 onto the printing medium 104 using the received power (S508), and then the process ends (S510). The printer can also detect whether the opening and closing part is open during warming of the heater in S506 or the printing operation in S508. When it is detected that the opening and closing part is open at this time, control can also be performed to stop the power transmission or reduce the transmitted power.

When a printing end signal (not illustrated) is received after this operation, the power supply control unit 405 sets the control voltage V4 with respect to the chopper circuit 403, and the transmission power from the power supply unit 404 and the power transmission antenna 102 is stopped (transmission power D=0).

With these operations, the printer sets the control voltage V2 in the chopper circuit 403 from the power supply control unit 405 during the printing and transmits the power used for the printing (transmission power B) to the carriage 101. After the printing ends, the printer sets the control voltage V4 in the chopper circuit 403 and stops the transmission power (transmission power D=0). As a result, power used by the carriage 101 is supplied without excess or deficiency based on the progress of die printing processing.

Since the power is not transmitted from the power transmission antenna 102 when printing is not performed, risks, such as electric shock to the user can be avoided. In this manner, since the power based on the state of the printer is wirelessly transmitted without transmitting the excess power in the operation in which the power consumption is low, the user can avoid risks, such as electric shock, while power consumption can be reduced.

### Second Exemplary Embodiment

According to a second exemplary embodiment, descriptions will be provided of an operation for changing the electric power amount to an optimal electric power amount based on the state of the printer (during the ink tank replacement) in the printer that transmits power to the carriage 101 using wireless power transmission. Since the configuration of the printer in the present exemplary embodiment is similar to the configuration described with reference to FIGS. 1 to 4 of the first exemplary embodiment, detailed descriptions thereof will be omitted.

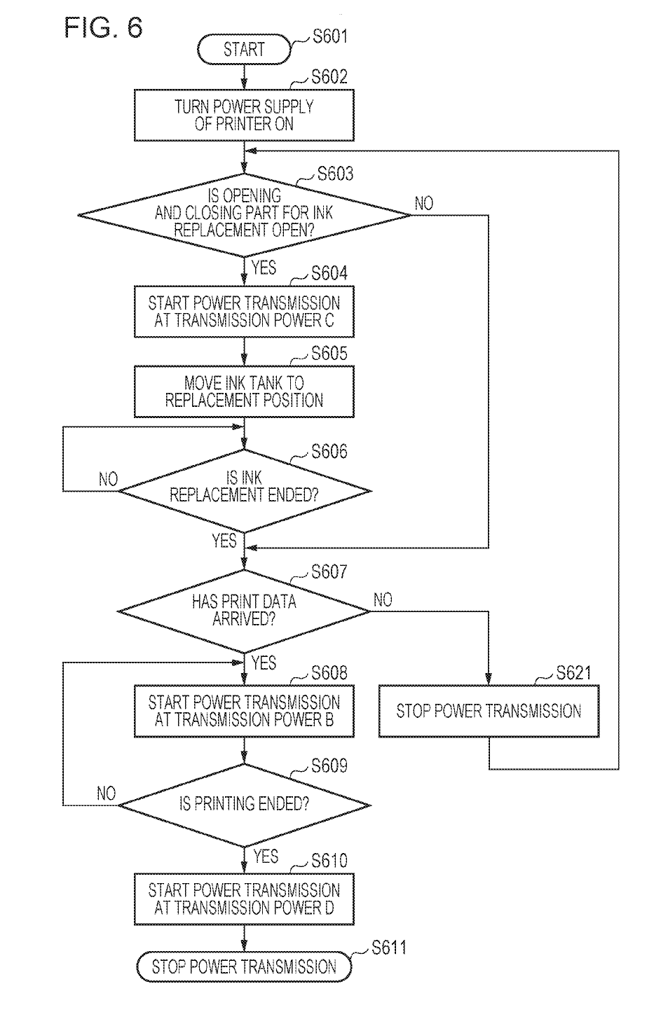

Processing of performing control on the optimal transmission power in the wireless power transmission when the ink tank included in the carriage 101 is replaced in the printer that performs wireless power transmission to the carriage 101 will be described with reference to FIG. 6. FIG. 6 is a flow chart illustrating an operation procedure of the printer according to the present exemplary embodiment. Respective steps in FIG. 6 are executed while the central processing unit 401 controls the respective components of the printer.

The process starts in S601, and the power supply of the printer is input (S602). Since the transmission power for wireless power transmission to the carriage 101 does not exist at this stage, the power supply control unit 405 of the central processing unit 401 sets the control voltage V4, and the power transmission is not performed (transmission power D=0).

Next, in S603, whether the opening and closing part used for the replacement of the ink tank of the printer is open is determined. The determination whether the part is open or closed is performed while the detection result by the sensor 411 included in the opening and closing part for the replacement of the ink tank is detected using the input port of the central processing unit 401.

In a case where it is determined that the opening and closing part for the ink tank replacement is closed as a result of the detection by the sensor 411 (S603: NO), the process proceeds to S607. In S607, the process stands by until the print data for the printing is received from an information processing apparatus, such as a personal computer. In a case where the print data is received within a certain period of time (S607: YES), the process proceeds to S608. In a case where the print data is not received (S607: NO) within a certain period of time, the process proceeds to S621.

In S621, VA kept as the control voltage output from the power supply control unit 405 to the chopper circuit 403, and the state continues where the power transmission to the carriage 101 by wireless power transmission is stopped (transmission power D=0). Subsequently, the process returns to S603.

In a case where the opening and closing part for the ink tank replacement is open (S603: YES), since the replacement of the ink tank is presumed, the ink tank is moved to a position where the ink tank can be replaced. Subsequently, the power supply control unit 405 outputs the control voltage V3 to the chopper circuit 403. As a result, the transmission power C is output from the power supply unit 404 via the power transmission antenna 102 (S604). The transmission power C indicates the electric power amount used for turning on or flashing an LED or the like to clearly indicate the specific ink tank to be replaced from among a plurality of ink tanks.

This electric power amount (transmission power C) is power lower than the power for driving the heater to warm up the ink head 454 (transmission power A) and the power consumed when printing is performed (transmission power B). The carriage 101 receiving the transmission power C by the power reception antenna 103 converts the power into DC power via the rectification unit 451, and consumes the converted power as, for example, the power for turning on or flashing the LED (not illustrated) of the ink tank with a low remaining amount of ink. The ink tank with the low remaining amount of ink is detected by the ink sensor 452. The ink detection unit 414 is notified of the detected result via wireless communication.

Next, the ink tank is moved to the position where the replacement is performed (S605), and the process stands by until replacement of the ink tank ends (S606). After the replacement of the ink tank ends (S606: YES), the process stands by for a certain period of time until the print data is received from an information processing apparatus, such as a personal computer (S607). After the ink tank replacement ends, the power supply control unit 405 sets the control voltage V4, and the transmission power for wireless power transmission stops (transmission power D=0).

In a case where the print data is transmitted (S607: YES), the power is transmitted at the power output level B so that the ink is ejected from the ink head 454 (S608). At this time, the control voltage V2 is output to the chopper circuit 403. This operation continues until printing (ink ejection) ends (S609). In a case where printing ends (S609: YES), V4 is set as the control voltage from the power supply control unit 405 (S610), and the power transmission by wireless power transmission stops (S611).

As a result, since the electric power amount used for turning on or flashing an LED or the like of the ink tank is transmitted to the carriage 101 at the time of the replacement of the ink tank, risks, such as possible electric shock of the user, at the time of replacement of the ink tank can be avoided.

According to the above-described exemplary embodiments, the following states are examples of operation states of the printer that switches the transmission power:

Operation state in which the ink head is warmed up by the heater (transmission power A).

Operation state in which the printing operation by the ink head is performed (transmission power B).

Operation state in which the ink tank for supplying the ink to the ink head is replaced (transmission power C).

Operation state in which the printing operation is stopped (transmission power D).

Triggers for switching the transmission power are not limited to these events. For example, control can be performed so that the power becomes predetermined transmission power in a case where the printing medium is replenished or replaced or a case where an internal temperature sensor indicates a particular value.

According to the respective above-described exemplary embodiments, the transmission power for wireless power transmission varies based on internal operations of a printer that transmits carriage operating power via wireless power transmission. As a result, among other advantages, risks, such as electric shock of a user, can be avoided.

### Other Exemplary Embodiments

According to the above-described exemplary embodiments, an example has been described in which wireless power supply to the carriage 101 is started based on a state in which a printer obtains print data. However, the printer can also start wireless power supply to the carriage 101 before print data is obtained. For example, power wirelessly supplied to the carriage 101 before the printer obtains the print data can be used for a preliminary operation, cleaning of the ink head 454, or processing for avoiding clogging of the ink head 454. In a case where the opening and closing part is detected to be open when wireless power supply to the carriage 101 is performed before or after the print data is obtained, the printer can reduce or stop the power supplied to the carriage 101.

In addition, a configuration has been described in which a printer restricts power supply to the carriage 101 in a case where the opening and closing part is opened and detachment or mounting of an ink tank can be performed. A different configuration can be adopted in which power supply to the carriage 101 is restricted when a state change of another component is detected. For example, a configuration in a case where the printer restricts power supply to the carriage 101 when it is detected that the ink tank is detached from the printer. Still yet another configuration can be adopted where the printer restricts power supply to the carriage 101 in a case where it is detected that a fixing part that fixes the ink tank, such that the ink can be supplied to the ink head, establishes a state in which the ink tank is not fixed from a state in which the ink tank is fixed.

One or more functions of the above-described exemplary embodiments can be realized by processing in which a program is supplied to a system or an apparatus via a network or a storage medium, and one or more processors in a computer of the system or the apparatus reads out and executes the program. In addition, one of more functions can also be realized by a circuit, e.g., an application specific integrated circuit (ASIC).

According to the present exemplary embodiment, technology can be provided with which power transmission control is performed based on the state of a printing apparatus in a printing apparatus that performs wireless power transmission.

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD or Blue-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-202037 filed Oct. 13, 2016, which is hereby incorporated by reference herein in its entirety.

What is claimed is:

1. A printing apparatus comprising:
an ejection unit configured to eject ink supplied from a detachable ink tank;
a power transmission unit configured to wirelessly supply power for the ejection unit to eject the ink;
a member including a first state in which detaching or mounting the ink tank is enabled and a second state in which detaching or mounting the ink tank is restricted; and
a control unit configured to set, when the member is in the first state, an amount of the wirelessly supplied power lower than an amount of the wirelessly supplied power when the member is in the second state.

2. The printing apparatus according to claim 1,
wherein the member is an opening and closing part of a casing of the printing apparatus,
wherein the first state is a state in which the opening and closing part is open, and
wherein the second state is a state in which the opening and closing part is closed.

3. The printing apparatus according to claim 1, wherein when the member is in the first state, power is not supplied to the ejection unit.

4. The printing apparatus according to claim 1, wherein, in a case where the member enters the first state from the second state, an amount of the wirelessly supplied power is decreased.

5. The printing apparatus according to claim 1, wherein in a case where the member enters the first state from the second state, power supply to the ejection unit stops.

6. The printing apparatus according to claim 1,
wherein the ejection unit includes a heater configured to perform warming for ejecting the ink, and
wherein the control unit sets, in an operation state in which the heater performs the warming before the ink is ejected, an amount of the wirelessly supplied power higher than an amount of the wirelessly supplied power in an operation state in which the ejection unit ejects the ink.

7. The printing apparatus according to claim 1,
wherein the ejection unit includes a heater configured to perform warming for ejecting the ink, and
wherein the control unit sets, in an operation state in which the heater performs the warming when the member is in the second state, an amount of the wirelessly supplied power higher than an amount of the wirelessly supplied power when the member is in the first state.

8. The printing apparatus according to claim 1, wherein the control unit sets, in an operation state in which the election unit ejects the ink when the member is in the second state, an amount of the wirelessly supplied power higher than an amount of the wirelessly supplied power when the member is in the first state.

9. The printing apparatus according to claim 1, further comprising a sensor configured to detect that the member is in the first state.

10. The printing apparatus according to claim 1, wherein the power transmission unit does not supply the power to the ejection unit when the member is in the second state and the ejection unit is in a standby state in which an operation for printing is not performed.

11. A control method for a printing apparatus including
an ejection unit configured to eject ink supplied from a detachable ink tank,
a power transmission unit configured to wirelessly supply power for the ejection unit to eject the ink, and
a member including a first state in which detaching or mounting the ink tank is enabled and a second state in which detaching or mounting the ink tank is restricted, the control method comprising:
setting, when the member is in the first state, an amount of the wirelessly supplied power lower than an amount of the wirelessly supplied power when the member is in the second state.

12. A non-transitory computer-readable storage medium storing a program for causing a computer to execute a control method for a printing apparatus including
an ejection unit configured to eject ink supplied from a detachable ink tank,
a power transmission unit configured to wirelessly supply power for the ejection unit to eject the ink, and
a member including a first state in which detaching or mounting the ink tank is enabled and a second state in which detaching or mounting the ink tank is restricted, the control method comprising:
setting, when the member is in the first state, an amount of the wirelessly supplied power lower than an amount of the wirelessly supplied power when the member is in the second state.
